(19) United States
(12) Patent Application Publication
(10) Pub. No.: US 2006/0286235 A1
(43) Pub. Date: Dec. 21, 2006

(54) Automatic baking apparatus

(76) Inventors: Thomas Kleinschnitz, Birkenfeld (DE); Jochen Hammer, Werneck (DE); Peter Leppich, Arnstein (DE); Dieter Engelhardt, Bischbrunn (DE)

Correspondence Address: MUIRHEAD AND SATURNELLI, LLC, 200 FRIBERG PARKWAY, SUITE 1001, WESTBOROUGH, MA, 01581, US

(21) Appl. No.: 11/402,296

(22) Filed: Apr. 11, 2006

(30) Foreign Application Priority Data
Apr. 11, 2005 (DE) 10 2005 016 769.1
Apr. 11, 2005 (DE) 10 2005 016 772.1

(51) Int. Cl. A23C 3/00

(52) U.S. Cl. 426/523

(57) ABSTRACT

The invention relates to an apparatus and process for controlling automatic baking in a retail store In on embodiment, the baking apparatus includes an oven, an infeed device for feeding in dough slabs and a transport mechanism for transporting the dough slabs from the infeed device through the interior of the oven to a delivery station at which the ready-baked goods are made available to customers. Further, the apparatus includes a data processing unit that: records the quantity of baked goods made available, receives by way of a data network from the retail store's point-of-sale system the number of baked goods sold, and prompts the baking apparatus to start up the baking process on the basis of a comparison of those two values. In one aspect, the present invention provides for control of the level for the delivery station together with devices present in the retail store.

### FIELD OF THE INVENTION

The invention relates to the field of baking and more particularly to an apparatus and process for controlling automatic baking in a retail store.

### BACKGROUND OF THE INVENTION

Prior art baking devices and processes are disclosed, for example, in the document EP 1 433 381 A1, which is incorporated herein by reference. Proposed therein are level detectors, which are used to control the filling level of the delivery station. It is proposed to continue the baking process until the level detector has reached a defined switching level.

Such level detectors necessitate additional sensor technology in the baking apparatus which can be susceptible to faults.

Accordingly, it is desirable to carry out a control of the level for the delivery station using the devices present in the retail store and to provide a simple and reliable control process for the operation of an automatic baking apparatus.

### SUMMARY OF THE INVENTION

According to one embodiment of the present invention, an automatic baking apparatus is disclosed including an oven, an infeed device for feeding in dough slabs and a transport mechanism for transporting the dough slabs from the infeed device through the interior of the oven to a delivery station at which the ready-baked goods are made available to customers. The apparatus further includes a data processing unit that:
records the quantity of baked goods made available,
receives by way of a data network from the retail store's point-of-sale system the number of baked goods sold, and
prompts the baking apparatus to start up the baking process on the basis of a comparison of those two values.

The data processing unit provided in the baking apparatus, for example a digital control unit, records the quantity of baked goods produced. This is possible without any major effort, e.g. by recording the dough slabs fed in by the infeed device. The infeed device, for example, delivers individual batches with a specific number of dough slabs. Every activation of the infeed device thus corresponds to the completion of said number of baked goods. The infeed device is also preferably activated by means of the digital control unit so that saving the number of activation processes directly provides the number of baked products made available.

According to another embodiment of the invention, the data processing unit of the baking apparatus is linked with a point-of-sale system present in the retail store. Modern point-of-sale systems accurately record the quantities of individual goods sold, e.g. by means of univocally assigned item numbers. By comparing the baked goods made available with the baked goods sold, it is possible to determine the difference between the number of baked goods made available and the number of baked goods sold. The result obtained is the number of baked goods that are still in the store. This value can be used to trigger a subsequent baking process of the automatic baking apparatus for the production of baked goods.

For example, a signal which is noticed by the store's staff may be generated for this purpose. Thereupon, the staff activate the baking apparatus and, for example, start up the baking of another batch with a predetermined number of baked goods.

Alternatively, the signal may be transmitted by means of data lines directly to the baking apparatus which then automatically start up the baking of a specific batch.

In a simple setting of said control process, subsequent baking can be started when the number of baked goods sold corresponds to the number of baked goods made available. This setting may, for example, be chosen if the baking apparatus is linked to an automatic delivery machine and an automatic payment machine for the baked goods. The baked goods are delivered to the customers directly at such an automatic delivery and payment machine after performing a payment process (with a credit card or by inserting cash). A new baking process is triggered as soon as the last baked product has been sold. However, the disadvantage of this setting is that the next customer must wait whilst the dough slabs pass through the oven.

In practice, therefore, subsequent baking can be triggered when the number of baked goods sold is smaller by a specific threshold value than the number of baked goods made available. Consequently, subsequent baking is triggered at a point in time when baked goods are still present in the delivery station. It is thus possible to ensure a continuous supply of baked goods.

At the same time, the data processing unit can take into account the speed of sale of the baked goods. Generally speaking, modern point-of-sale systems are also provided with a timer device. In addition to the number and type of goods sold, the times of individual sales procedures are also recorded. From this data it is possible to determine the speed of sale applicable in each case, that is to say, the number of baked goods sold per unit of time. The speed of sale may be taken into account using the process according to the invention. For example, if a baking process takes ten minutes after being started up, it is possible by multiplying this time period with the current speed of sale to predict how many baked goods will be sold during the time taken by the baking process. The number determined then corresponds to the minimum threshold value to be selected. If necessary, it is possible to add a safety margin to this number so that a continuous supply of the baked goods is ensured.

Modern monitoring systems for supermarkets often record not only the sales data as a point-of-sale system but also information about the number of customers in a retail store via people counting devices. This number is used, for example, for manning the store's point-of-sales terminals. For example, only one point-of-sales terminal is manned when the number of customers is low whereas a plurality of point-of-sales terminals is manned when the number of customers is high.

The number of people in the store can also be taken into account for determining the threshold value. In a supermarket a customer needs a specific amount of time to get from a shelf or another goods delivery station to the point-of-sale. During this time he has the goods picked up in his shopping trolley. The goods have not yet been recorded by the store's point-of-sale system. If there is a large number of customers in the store, inevitably there is also a large number of items in the shopping trolleys, amongst which are also the baked goods referred to, which have not been recorded by the point-of-sale terminal. Thus, when customer traffic is high, the threshold value must be set higher than when customer traffic is low.

In addition to the proposed automatic procedure for specifying the threshold value, the threshold value may also be entered manually by the sales staff based on their own experience and observations.

The process according to this embodiment of the invention can also be used for a complex baking apparatus in which the infeed device feeds a plurality of different goods into the oven. In this embodiment, the data processing unit records the quantity of each of the baked goods made available and receives the number of each of the different baked goods sold from the store's point-of-sale system by way of a data network. Then, for each of the different baked goods the baking apparatus initiates subsequent baking allowing for a threshold value and the factors referred to above.

Consequently, the invention is also provides for an automatic baking apparatus for a retail store, comprising an oven, an infeed device for feeding in dough slabs and a transport mechanism for transporting the dough slabs from the infeed device through the interior of the oven to a delivery station at which the ready-baked goods are provided for removal by customers.

According to this embodiment of the invention, the automatic baking apparatus has a data processing unit with a data interface for exchanging data with a point-of-sale system of the retail store.

Automatic baking stations are usually intended for large retail stores with a plurality of point-of-sale terminals. The point-of-sale terminals are integrated into a point-of-sale system with central data acquisition and data management. The point-of-sale system usually has a control computer which has the required data processing units (CPU, working memory and bulk storage devices such as hard drives).

The data processing unit of the automatic baking apparatus need not necessarily be disposed close to the oven. It is also possible for the data processing unit to be disposed remotely from the oven. The control tasks for the baking apparatus may also be carried out by a computer of the point-of-sale system. What is important is that the point-of-sale system's data acquisition is linked up to the control computer for the automatic baking apparatus.

The baking apparatus includes a signalling means if subsequent baking process is initiated by the sales staff. This may be disposed on the oven and/or on at least one point-of-sale terminal and/or in a portable module.

Likewise, the baking apparatus includes inputting means for control commands. These, too, may be disposed on the oven, at the point-of-sale terminal and/or in a portable module.

If the signalling means and the inputting means are disposed on the oven, it is possible for the sales staff to check the proper condition of the oven and the baking apparatus by visual inspection.

Disposal of the signalling means and the inputting device at the point-of-sale terminal has the advantage that a sales assistant who is busy taking money can enter the necessary control commands without leaving the work area.

A portable module for rendering of the signals and transmission of the control commands leads to a great deal of flexibility. A portable module, for example, can establish a data connection with the baking apparatus' data processing unit by wireless means. It is possible to generate a signal by way of warning lights, a screen display or even a vibrating means of the portable module which alerts the wearer of this module to the fact that an input is necessary. The input may be made by any inputting means (keyboard, touchscreen, etc.). The commands inputted are transmitted to the baking apparatus by way of the wireless data connection.

Due to the wireless module, the person who operates the baking apparatus is not tied to one place and can perceive the signals and input the control commands anywhere in the retail store. In this case the signalling means and inputting means may form one unit inside a common housing of the portable module.

Further, according to another embodiment of the invention, the baking apparatus is programmed by way of a control unit so that it is prompted at a specific time to bake at least a specific quantity of one specific baked product and to make it available in the delivery station.

This programming may take place in conjunction with the data connection to the point-of-sale system described above or independently thereof.

Fixed pre-programming of the provision of specific batches has the advantage that the baking apparatus can be operated with very simple and sturdy infeed means that deliver the dough slabs in batches. Furthermore, there is no need for the complex sensor technology and control electronics that are necessary for constant monitoring of filling levels.

In practice, the infeed device can be designed for the infeed of a plurality of different baked goods which are made available in various sections of the delivery station after passing through the oven. The control unit can be programmed such that the baking apparatus bakes specific quantities of the respective different baked goods and makes them available in the respective different sections of the delivery station.

According to this process embodiment of the invention, infeed devices for individual infeed can be combined with infeed devices with batch infeed. Calling off of the dough slabs from the various infeed devices is carried out according to the specified quantities of baked goods to be produced.

In particular, the invention enables the execution of a night baking program. It has been possible to date to pre-program the switching on time in professional ovens. The ovens were switched on e.g. 30 minutes before the bakery opened so that when the staff arrived they were pre-heated and ready for use and there was no occurrence of unnecessary waiting times. In accordance with the process according to the invention, it is possible when using an automatic store baking station to complete the entire baking process, including pre-heating of the oven, infeed of the dough slabs and their transport from the infeed device through the interior of the oven to the delivery station, before the retail store opens. The time for commencement of the baking process is selected to be a certain period of time prior to opening of the retail store so that the specific quantity of one or quantities of a plurality of baked goods is/are made available in the delivery station by the time the store opens.

In particular, deep-frozen dough slabs, which remain capable of being processed for a period of 48 hours after removal from the cold store, are suitable for the baking of dough slabs in automatic baking stations. Therefore, it causes no problem to load the infeed device with dough slabs in the evening at the end of business and to program the control unit such that the dough slabs are baked the next morning following the preset baking program. Even if there is a day on which the store is closed between loading up the dough slabs and opening of the store, the dough slabs are still capable of being processed at the beginning of the baking process.

It is possible to store specified or dynamically determined combinations of quantity information for the various baked goods in the control unit, e.g. the manufacturer can specify a meaningful and frequently used combination. For example, seventy normal rolls, thirty-five wholemeal rolls and twelve baguettes are specified. This combination need not be entered manually but can be activated by pressing a single button.

The control unit can also store the combination of quantity details called up for the various baked goods in the control unit in each case and evaluate them statistically. It is then likewise possible to activate the most frequently used combination via function keys with a single press of a button.

In addition, the average combination of quantity details selected for the various baked goods can also be called up by way of the control unit by using a specific function key.

The combinations selected prior to opening of the store can be considered separately so that in this case too the most frequent or average combination of quantity details for the various baked goods can be called up via the control unit by a quick entry or a function key.

### BRIEF DESCRIPTION OF THE DRAWINGS

Embodiments of the invention are described in the following with reference to the attached drawings, in which:

FIG. 1 is a schematic side view of a baking apparatus according to one embodiment of the invention;

FIG. 2 is a diagrammatic representation of a point-of-sale system according to one embodiment of the invention;

FIG. 3 is a top view onto a wireless module according to one embodiment of the invention;

FIG. 4 is a side view of the closed housing of the baking apparatus according to one embodiment of the invention; and

FIG. 5 is an enlarged representation of an input screen of the baking apparatus according to one embodiment of the invention.

### DETAILED DESCRIPTION OF VARIOUS EMBODIMENTS OF THE INVENTION

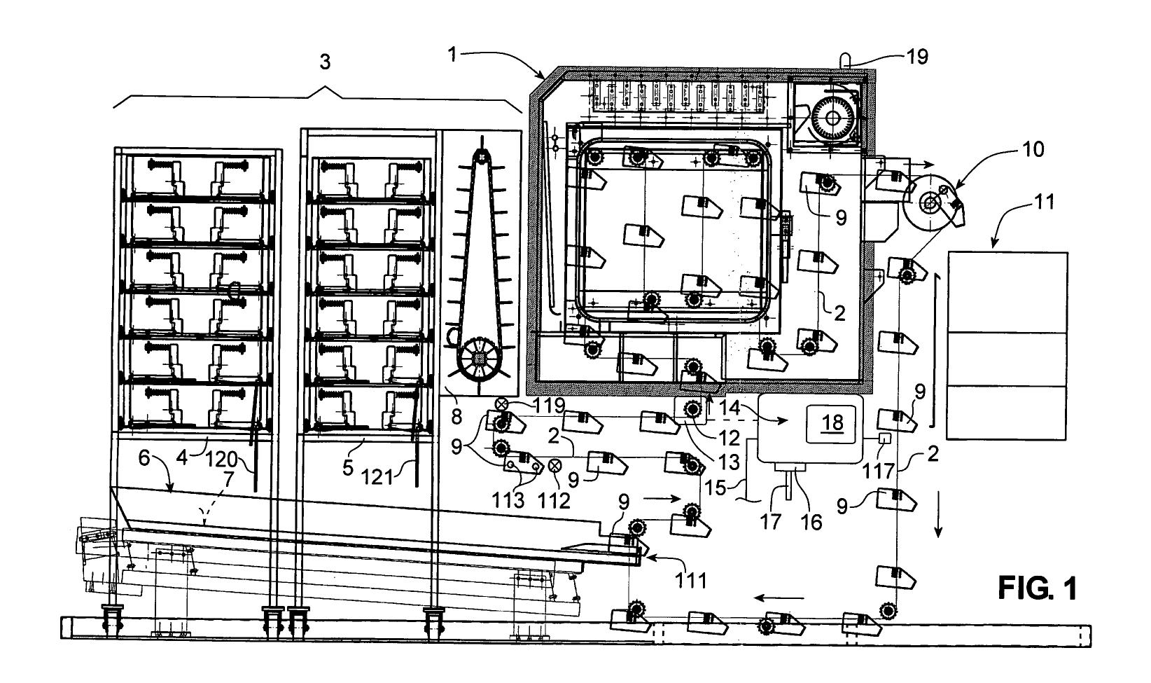

The baking apparatus shown in FIG. 1 comprises an oven 1 for baking dough slabs or dough shapes, which are mostly slightly defrosted, completely thawed or deep-frozen and/or par-baked and which are fed automatically into the baking compartment of oven 1 by a transport mechanism. Oven 1 is thermally insulated and has an inspection window on the side visible in FIG. 1. The side wall of oven 1 is shown as transparent to make the layout clearer. The dough slabs are not shown in FIG. 1.

A transport mechanism which has a pair of conveyor chains 2 circulating at a distance from and parallel to each other is provided for transporting the dough slabs into oven 1. Again for reasons of clarity, the course of conveyor chains 2 is only illustrated by a thin line in FIG. 1. As conveyor chains 2 also run through the heated baking compartment of oven 1, they are preferably manufactured from heat-resistant materials, especially from steel.

In addition, the baking apparatus in FIG. 1 comprises an infeed device 3 which consists of a plurality of elements. On one hand two loading trolleys 4 and 5 are shown on which dough slabs, especially par-baked rolls, are disposed in different layers. Underneath loading trolleys 4 and 5 is disposed a trough 6, the bottom surface of which forms an inclined sliding surface 7.

Whilst loading trolleys 4 and 5 transport dough slabs for rolls which fall onto sliding surface 7, a supply magazine 8 for longish bakery products, especially baguettes, is disposed on the side of loading trolley 5 facing towards oven 1.

Between conveyor chains 2 are disposed carrying means 9 each extending transversely with respect to the plane of FIG. 1 which pick up the dough slabs and transport them into the baking compartment of oven 1. In the baking compartment of oven 1, transport chains 2 which are parallel to each other follow a winding course so that carrying means 9 remain inside the baking compartment of oven 1 for a sufficiently long time. The carrying means 9 are attached to the pair of conveyor chains in the manner of a gondola. For this they are attached so as to be pivotable around an axis extending transversely to pair of conveyor chains 2. Due to their centre of gravity being below the axis of rotation, they remain, without any external influence, in the position shown in FIG. 1 in which their contact surface runs essentially horizontally or if necessary is inclined at a slight angle towards the bottom right-hand side of FIG. 1.

At the exit from the baking compartment of oven 1 is provided a delivery station 10 at which the fully baked bakery goods are removed from carrying means 9. Delivery station 10 also includes a plurality of containers 11, from which the customers can take the ready-baked goods. The various baked goods made available by infeed device 3 can be assigned to different containers 11 by means of a sorting device.

The power supply for the baking apparatus and the data processing unit, which controls the baking apparatus, is accommodated in control box 14 represented schematically underneath oven 1 in FIG. 1.

Further, a drive pinion 12, which meshes with conveyor chain 2, is driven by a drive motor 13. Drive motor 13 drives a corresponding pinion on the opposing side in the same direction of rotation. Drive motor 13 is likewise connected to a power supply inside control box 14.

Furthermore, FIG. 1 shows two data interfaces on control box 14 with the data processing unit. A data line 15 as first data interface permits data exchange by way of a permanently wired data network. A data transfer module 16, which is provided with an antenna 17, forms the second data interface and enables contact-free wireless data transfer. Such data transfer modules for various digital devices are known for example as Bluetooth data interfaces. Data interfaces 15, 16 enable data communication between the data processing unit in control box 14 and the external devices described below.

Control box 14 has a touch-sensitive screen 18 on its visible front side. This serves on one hand to display certain status messages or signals. In addition, data entries may be made by way of said touch-sensitive screen 18, also referred to as a touchscreen. A further signalling device can be seen on the top of oven 1 in the form of a signal lamp 19.

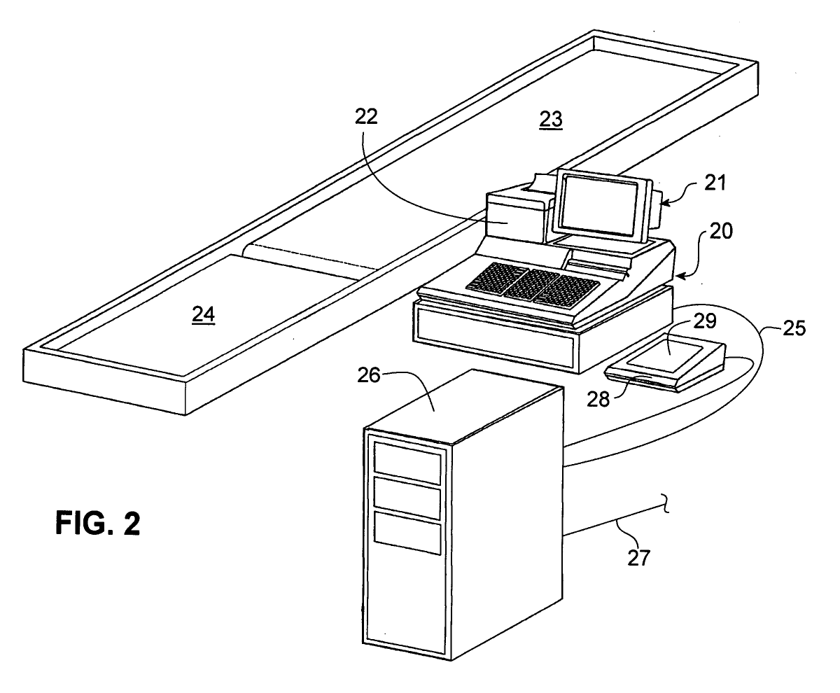

FIG. 2 shows a point-of-sale system 10, which is linked to the baking apparatus of FIG. 1. The point-of-sale system comprises an electronic point-of-sale terminal 20 with a display screen 21 and a printer 22 for sales slips. It is linked in the conventional manner to a belt conveyor 23 and a weighing unit 24 in extension of belt conveyor 23. Products may be weighed for charging using weighing unit 24.

Point-of-sale terminal 20 is connected to a central computer 26 of the point-of-sale system by way of data line 25. The spatial arrangement of central computer 26 need not correspond to that shown in FIG. 2. Central computer 26 may be disposed remotely from point-of-sale terminal 20. Usually in larger retail stores a plurality of point-of-sale terminals 20 is connected to central computer 26.

FIG. 2 also shows a data line 27 which is connected to a data interface of central computer 26. This data line 27 is connected to data line 15 in FIG. 1. The point-of-sale terminal 20 records the goods sold on the basis of their item numbers and saves the numbers of goods sold in each case to a data memory of central computer 26. These quantities can be transmitted by way of data lines 27, 15 to the data processing unit in the control box 14 and related to the numbers recorded there of baked goods made available. Alternatively, it is of course possible for the data processing unit to carry out the comparison within central computer 26.

A signal is transmitted when the difference between the baked goods made available and the goods sold falls below a critical threshold value. On the basis of the signal, the staff of the retail store can enter a control command which prompts the baking apparatus of FIG. 1 to generate a new batch of baked goods.

The control commands can be entered by way of touchscreen 18 on control box 14 of the baking apparatus. Alternatively or in addition, it is possible to dispose an input module 28 directly next to point-of-sale terminal 20. It is possible to enter a control command by way of input module 28 which is passed on by way of data lines 27, 15 to control box 14 of the baking apparatus. In the present case, input module 28 has a touch-sensitive screen 29 which enables the entry of control commands on one hand and displays signals of the baking apparatus on the other hand, especially when it is necessary to restart baking for producing additional baked goods.

Further signalling means which serve to alert the sales staff may be provided. For example, signal light 19 on oven 1 may be used to signal that an input command is necessary.

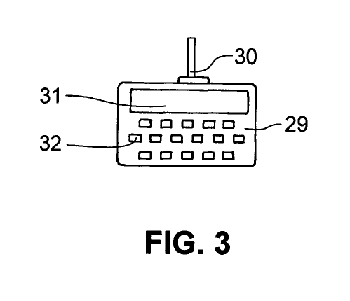

Finally, a wireless input module 29 (FIG. 3) may be used for entering input commands. Wireless input module 29 is likewise provided with an antenna 30 which communicates with antenna 17 on control box 14 of the baking apparatus. It also has a display 31 on which operating conditions of the baking apparatus may be displayed. Finally, keys 32 are provided for entering input commands. Of course, wireless input module 29 can also be provided with a touchscreen for displaying messages and entering control commands. The display of wireless input module 29 may be used to render signals. However, wireless display module 29 can also emit an acoustic signal or may be provided with a vibration battery which generates a haptically detectable vibration signal. Such vibration batteries are known from mobile telephones and enable the signal to be rendered to the appropriate person wearing the device without other people being annoyed by disturbing noises.

The system according to the invention exhibits the greatest possible flexibility when all the different inputting and signalling devices, that is, touchscreen 18 on control box 14 of the baking apparatus, input module 28 at point-of-sale terminal 20 and wireless input module 29, are combined with each other.

Reference number 111 relates to a transfer point at which the dough slabs are transferred from trough 6 to a carrying means 9. It can be seen that said carrying means 9 passes by from bottom to top close to the trough. At the same time prongs (not shown) of carrying means 9 engage with slots in trough 6. The dough slabs which lie in the slotted area of the trough are thus lifted up by the prongs of carrying means 9.

Provided at the exit from the baking compartment of oven 1 is a delivery station 10 at which the ready-baked goods are removed by carrying means 9.

Further, FIG. 1 shows said drive pinion 12 meshing with said conveyor chain 2 and being driven by said drive motor 13. In practice, the drive motor and the driven pinion may also be provided at any other point of conveyor chain 2. For example, the large pinion shown in the vicinity of delivery station 10 is also suitable for driving conveyor chain 2.

A motion sensor 117 linked to control box 14 contains a coil and works by induction. Each time a carrying means 9, which is made of sheet steel, passes by at a short distance from motion sensor 117, said sensor outputs a signal which is routed to control box 14 by way of a signal line. In this way an electronic transmitter inside control box 14 can monitor proper operation of conveyor chain 2.

In addition, light barriers 112 and 119, which serve to control and monitor the baking apparatus, are disposed in the movement paths of carrying means 9 or of the dough slabs. Light barrier 112 co-operates with openings 113. Such openings 113 are present on all carrying means but are drawn in exclusively on carrying means 9 downstream of light barrier 112. As soon as carrying means 9 comes into the vicinity of light barrier 112, light barrier 112 is interrupted and the signal of the receiver of light barrier 112 changes. This signal is fed to an evaluation unit in control box 14 which infers from the signal that a carrying means 9 has been moved past the light barrier. If carrying means 9 continues to move, the receiver again receives the light of light barrier 112 at the two openings 113 when a carrying means is empty. If carrying means 9 is full, the receiver remains dark for at least one of openings 113.

Thus the signal of light barrier 112 renders both the passage of a carrying means 9 and also the presence of a dough slab on carrying means 9.

It is possible to trigger discharge of a dough slab from supply carousel 8 if an empty carrying means 9 is transported underneath the discharge opening of said supply carousel 8 whilst being further transported by conveyor chain 2. In this case, light barrier 119 underneath supply carousel 8 determines whether a dough slab actually drops onto carrying means 9. If this is not the case, the supply carousel is re-activated by the control electronics in control box 14 until a dough slab actually drops onto carrying means 9. The traction speed of the carrying means is low enough, due to the fact that the carrying means remain inside the baking compartment of oven 1 for several minutes, to enable supply carousel 8 to carry out several discharge sequences whilst carrying means 9 is situated underneath the discharge opening.

The baking apparatus described can be programmed by way of control unit 14 such that it produces specific batches of baked goods. In each of the two loading trolleys 4 and 5 are provided six compartments situated one above the other, the compartment floors of which can be opened individually and one after the other. In FIG. 1 the two lower right-hand compartment floors 120 of left-hand loading trolley 4 and the two lower right-hand compartment floors 121 of right-hand loading trolley 5 are shown as being open. On the large loading trolley 4, thirty-five rolls are disposed on each compartment floor 120 which extends across half the compartment. On small loading trolley 5, which is provided for wholemeal rolls for example, twenty dough slabs are disposed on each compartment floor 121. The dough slabs for the baguettes from supply carousel 8 can then be fed in individually whenever it is determined that an empty carrying means 9 is situated underneath the discharge opening of supply carousel 8.

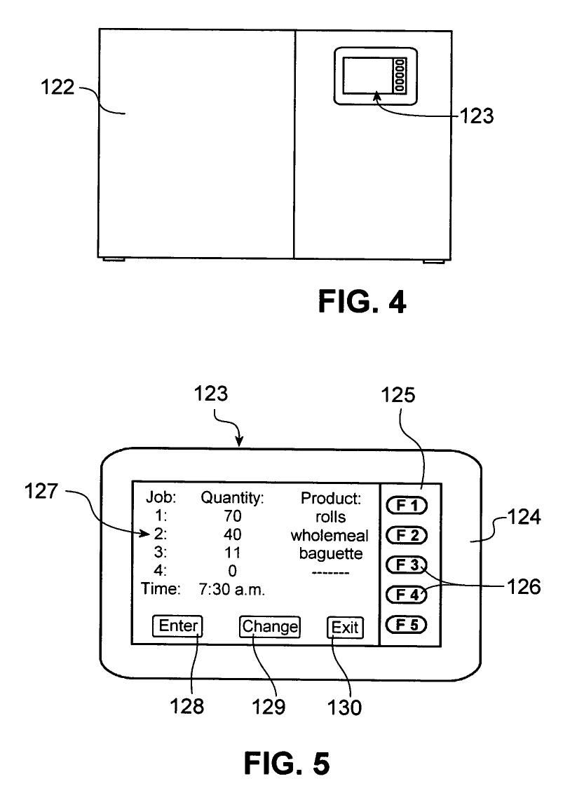

FIG. 4 shows a side view of housing 122 of the baking apparatus from FIG. 1. A touch-sensitive screen 123, also known as a touchscreen, is provided for inputting control commands which are then passed on to control unit 14 (FIG. 1). Touchscreen 123 is shown enlarged in FIG. 5. It includes a frame 124, a function key strip 125 with individual function keys 125 and a touch-sensitive input field 127, in which contact with a pen or a finger is detected by way of the electrical conductivity. Input field 127 is transparent, and behind it is disposed a TFT screen which is actuated as a function of the input. The data processing unit, which controls the input by way of input field 127 as well as the display by way of the display monitor situated behind it, is likewise accommodated in control box 14.

The screen in FIG. 5 shows a typical baking program for a night baking job. The intention is to produce seventy normal rolls, forty wholemeal rolls and eleven baguettes. To do this, two compartment floors 120 of large loading trolley 4 from FIG. 1 must be opened and the dough slabs of the rolls falling out as a result are to be baked and fed into a corresponding container 11 for removal at delivery station 10. After completion of this baking job, two compartment floors 121 of small loading trolley 5, which is loaded with wholemeal rolls, open. As soon as it is determined by way of light barrier 112 that the carrying means are no longer carrying any wholemeal rolls, the supply carousel is prompted to discharge dough slabs for white bread sticks (baguettes).

Certain areas 128-130, to which specific input functions are assigned, are delineated by the display on touch-sensitive input field 127. It is possible to modify the baking job entered by using them.

It is also possible to use function keys 126 to modify the baking job.

The starting time for the baking job is set to 7.30 am. Thus there are 90 minutes remaining until the normal opening time of a retail food store at 9.00 am in which to heat up the oven and bake the baking orders collated in the baking job. When the retail store opens at 9.00 am, the baked goods called off the previous evening are ready for removal by customers. The only thing necessary on the previous evening is to input the baking job, as described, and to make the required quantity of dough slabs available to the baking apparatus by way of infeed device 3.

A function key 126, e.g. function key F5, may serve to switch the baking apparatus off into a standby condition. In this case all drive motors and heating devices are disconnected from the power supply by way of control box 14. Only the electronic data processing unit inside the control device is supplied with electricity to the extent that its timer is monitored and at 7.30 am it activates the baking program. At this moment, the baking apparatus is switched on automatically and infeed device 3 is activated once oven 1 has heated up.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. Process for controlling an automatic baking apparatus, the apparatus comprising an oven, an infeed device for feeding in dough slabs and a transport mechanism for transporting the dough slabs from the infeed device through the interior of the oven to a delivery station at which the ready-baked goods are made available to customers, the process comprising using a data processing unit to:
record a quantity of baked goods made available;
receive by way of a data network from a retail store's point-of-sale system a number of baked goods sold; and
prompt the baking apparatus to start up the baking process on the basis of a comparison of said quantity of baked goods made available and said number of baked goods sold.

2. The process according to claim 1, further comprising: generating a signal to prompt activation of the baking apparatus as a result of the comparison.

3. The process according to claim 1, wherein a signal which activates the baking apparatus is routed to the baking apparatus as a result of the comparison.

4. The process according to claim 1, wherein a predetermined number of baked goods is baked due to activation of the baking apparatus.

5. The process according to claim 1, wherein starting up of baking is prompted when the number of baked goods sold corresponds to the number of baked goods made available.

6. The process according to claim 1, wherein start up of baking is prompted when the number of baked goods sold is smaller by a specific threshold value than the number of baked goods made available.

7. The process according to claim 6, wherein the data processing unit records the number of baked goods sold per unit of time and determines the threshold value taking this value into account.

8. The process according to claim 6, wherein the data processing unit records the number of customers in the retail store by means of a person counting device and determines the threshold value taking this number into account.

9. The process according to claim 1, wherein the infeed device feeds in a plurality of different baked goods and the data processing unit records the quantity of each of the different baked goods made available, and receives the number of each of the different baked goods sold from the retail store's point-of-sale system by way of the data network, and prompts the baking apparatus to bake replacements for the different baked goods based on the comparison of these values.

10. Automatic baking apparatus, comprising:
an oven;
an infeed device for feeding in dough slabs;
a transport mechanism for transporting the dough slabs from the infeed device through an interior of the oven to a delivery station at which the ready-baked goods are made available to customers; and
a data processing unit with a data interface for exchanging data with a point-of-sale system of a retail store.

11. The baking apparatus according to claim 10, further comprising: a signalling means.

12. The baking apparatus according to claim 11, wherein the signalling means is disposed in or on at least one of the following:
the oven
at least one point-of-sale terminal of the point-of-sale system
a portable module which is linked to the baking apparatus by way of a wireless data connection.

13. The baking apparatus according to claim 11, wherein said signalling means includes at least one of:
a display screen for rendering a warning message;
a signal lamp;
a sound generator to emit an audible signal; and
a portable vibration means to generate a vibrating alarm.

14. The baking apparatus according to claim 10, further comprising an inputting means for inputting control commands.

15. The baking apparatus according to claim 14, wherein the inputting means is disposed in or on at least one of the following:
the oven;
at least one point-of-sale terminal of the point-of-sale system; and
a portable module which is linked to the baking apparatus by way of a wireless data connection.

16. The baking apparatus according to claim 14, wherein said inputting means includes at least one of:
a touch-sensitive screen; and
a keyboard.

17. The baking apparatus according to claim 10, further comprising a signalling means and an inputting means that are disposed in a common housing.

18. Process for controlling an automatic baking apparatus, the apparatus comprising an oven, an infeed device for feeding in dough slabs, and a transport mechanism for transporting the dough slabs from the infeed device through the interior of the oven to a delivery station at which the ready-baked goods are made available to customers, the process comprising:
programming the baking apparatus by way of a control unit so that said baking apparatus is prompted at a specific time to bake a specific quantity of at least one specific baked product and make said specific quantity of the at least one specific baked product available in the delivery station.

19. The process according to claim 18, wherein the infeed device is designed for feeding in a plurality of different baked goods, which are made available in different sections of the delivery station after passing through the oven, and wherein the control unit is programmed such that the baking apparatus bakes specific quantities of the respective different baked goods and makes them available in the respective different sections of the delivery station.

20. The process according to claim 18, wherein the specific time is selected to be a specific period of time prior to opening of the retail store so that the specific quantity of one or quantities of a plurality of baked goods is/are made available in the delivery station by opening of the retail store.

21. The process according to claim 20, wherein within said specific period of time the oven is pre-heated, the infeed device and the transport mechanism are activated, the baked goods are transported through the oven and the delivery station is filled.

22. The process according to claim 18, wherein a defined combination of quantity information for the various baked goods is stored in the control unit.

23. The process according to claim 18, wherein a combination of quantity details for the various baked goods is inputted manually.

24. The process according to claim 18, wherein a combination of quantity details for the various baked goods is stored and evaluated statistically in the control unit.

25. The process according to claim 24, wherein a most frequently selected combination of quantity details for the various baked goods is called up by way of the control unit.

26. The process according to claim 24, wherein an average selected combination of quantity details for the various baked goods is called up by way of the control unit.

27. The process according to claim 24, wherein a most frequently selected combination of quantity details for the various baked goods selected prior to opening of the retail store is called up by way of the control unit.

28. Method for automatically controlling a baking process, comprising:
recording a quantity of available baked goods;
receiving from a data network of a point-of-sale system a number of baked goods sold;
comparing said quantity of available baked goods with said number of baked goods sold to generate a comparison value; and
automatically controlling initiation of the baking process based on said comparison value.
